(19) United States
(12) Patent Application Publication
(10) Pub. No.: US 2007/0257799 A1
(43) Pub. Date: Nov. 8, 2007

(54) METHOD AND STRUCTURE FOR LOCALIZING OBJECTS USING DAISY CHAINED RFID TAGS

(76) Inventors: Frederic Bauchot, Saint-Jeannet (FR); Jean-Yves Clement, Saint-Jeannet (FR); Gerard Marmigere, Drap (FR); Joaquin Picon, St. Laurent Du Var (FR)

Correspondence Address: SCHMEISER, OLSEN & WATTS, 22 CENTURY HILL DRIVE, SUITE 302, LATHAM, NY, 12110, US

(21) Appl. No.: 11/688,270

(22) Filed: Mar. 20, 2007

(30) Foreign Application Priority Data
Apr. 12, 2006 (EP) 06300355.2

(51) Int. Cl. G08B 13/14

(52) U.S. Cl. 340/572.1; 340/10.1; 340/572.7; 340/572.8

(57) ABSTRACT

A Radio Frequency Identification (RFID) structure. The RFID structures includes a tag stack of N essentially identical RFID tags and an object stack of N essentially identical objects. N is at least 2. Each tag is attached to a corresponding object and includes an electronic chip, an antenna, and at least one pair of electrical contacts. The N tags are daisy chained together in electrical contact via the at least one pair of electrical contacts in the tags. The tag stack is configured to receive power from an external power source located outside of the RFID structure. A method for localizing an object in the object stack includes receiving an external signal in each tag via the antenna, and enabling or not enabling a lighting of a lighting device in each tag in dependence upon data in the external signal.

### FIELD OF THE INVENTION

The present invention relates generally to a method and system for localizing objects and more specifically to a method and system for localizing an object among a set of stacked objects equipped with improved Radio Frequency Identification (RFID) tags.

### BACKGROUND OF THE INVENTION

In the previous millennium, mediatheques were merely libraries with shelves full of books. Finding a book in a library was not always an easy task to do, but was nevertheless facilitated by their various formats, colors, sizes and materials. Thus, discriminating between a cook book, a dictionary, a comic book, an atlas, a schoolbook, a picture book, a prayer book, a cashbook, an account book, was not difficult. With the recent explosion of electronic media, it is today quite common to find all these different books recorded on a common media following worldwide standards in terms of physical form factor, size and even colors. Either CDs or DVDs can record various types of information, such as text and images as in books did, and also sound and video. The result is that state of the art mediatheques now have shelves full of objects that follow the same format. Finding a given object within such a mediatheque becomes much more demanding than it was in the past.

To overcome this difficulty, the RFID technology provides an interesting capability to allow unique identification of a Radio Frequency Identification (RFID) tag, and subsequently the object it is attached to. For example, U.S. Pat. No. 6,693,539 discloses an article inventory control system for articles, such as books, using RFID tags attached to the articles. Each tag has a unique identification or serial number for identifying the individual article. An inventory database tracks all of the tagged articles and maintains circulation status information for each article. Articles are checked out of the library using a patron self-checkout system. Checked out articles are returned to the library via patron self-check in devices. The shelves are periodically scanned with a mobile RFID scanner for updating inventory status.

The current RFID technology allows assignment of a unique identifier to a RFID tag, so that this tag can be uniquely identified when read by a RFID reader. Establishing a one-to-one relationship between the RFID tag and the object it is attached to, allows consequently unique identification of a given object among a set of objects. Thus, an obvious solution for localizing objects in shelves consists of attaching an RFID tag onto each object, to associate each object with the attached RFID tag, and then reading the RFID tag identifier by an RFID reader. To make such a solution affordable, the RFID tags have to be inexpensive, robust and thin, so that only passive RFID tags are considered. This limitation brings a cumbersome constraint as the reading range of passive RFID tags is quite limited, typically few inches. In order to locate a given object within a set of shelves, the reader will have to pass close to each shelf, scanning all of its width. This requires either a tedious and precise manual operation, or use of an expensive robot. Active RFID tags do not suffer from this short reading range, but are unfortunately not well suited, due to their price and more importantly due to the fact that they have to include a power source (such as a battery) which imposes stringent form factor constraints.

Therefore, there is a need for RFID tags allowing long reading range while being equivalent in terms of size, form factor, and price to the passive RFID tags, for identifying objects in mediatheques.

### SUMMARY OF THE INVENTION

The present invention provides a Radio Frequency Identification (RFID) structure comprising a tag stack of N essentially identical RFID tags and an object stack of N essentially identical objects:

wherein N is at least 2;

wherein each tag of the N tags is attached to a corresponding object of the N objects;

wherein the N tags are denoted as T₁, T₂, . . . , T_{N};

wherein each tag comprises an electronic chip, an antenna, and at least one pair of electrical contacts, said at least one pair of electrical contacts of T₁, T₂, . . . , T_{N} respectively denoted as C₁, C₂, . . . , C_{N};

wherein the N tags are daisy chained together such that Cᵢ is in electrical contact with Cᵢ₊₁ for i=1, 2, . . . , N−1;

wherein in each tag, the antenna is configured to receive an external signal from outside the RFID structure and to transmit the external signal to the chip which is configured to receive the signal from the antenna via an electrical connection between the antenna and the chip; and

wherein the tag stack is configured to receive power from an external power source located outside of the RFID structure.

The present invention provides a method for localizing an object in a Radio Frequency Identification (RFID) structure that comprises a tag stack of N essentially identical RFID tags and an object stack of N essentially identical objects, said method comprising:

receiving by the N tags an external signal from outside the RFID structure,
wherein N is at least 2,
wherein each tag of the N tags is attached to a corresponding object of the N objects,
wherein the N tags are denoted as T₁, T₂, . . . , T_{N},
wherein each tag comprises an electronic chip, an antenna, and at least one pair of electrical contacts, said at least one pair of electrical contacts of T₁, T₂, . . . , T_{N} respectively denoted as C₁, C₂, . . . , C_{N},
wherein the N tags are daisy chained together such that Cᵢ is in electrical contact with Cᵢ₊₁ for i=1, 2, . . . , N−1,
wherein the tag stack is receiving power from an external power source located outside of the RFID structure,
wherein each tag comprises a lighting device such that the chip in each tag is electrically connected to the lighting device in each tag,
wherein in each tag, the antenna receives the external signal; and in each tag,
transmitting the external signal from the antenna to the chip via an electrical connection between the antenna and the chip,
receiving, by the chip, the external signal transmitted by the antenna,
extracting, by the chip, data in the external signal received by the chip, and enabling or not enabling, by the chip, a lighting of the lighting device in dependence upon the extracted data.

The present invention advantageously provides RFID tags allowing long reading range while being equivalent in terms of size, form factor, and price to the passive RFID tags, for identifying objects in mediatheques.

### BRIEF DESCRIPTION OF THE DRAWINGS

FIG. 1 depicts an example of the architecture of a passive RFID tag.

FIG. 2A shows a Radio Frequency Identification (RFID) system with a RFID reader having an antenna and a RFID tag having a dipole antenna.

FIG. 2B illustrates the signal emitted by the antenna of the RFID reader and the modulated signal reflected by the RFID tag.

FIGS. 3A, 3B, and 3C, illustrate the daisy chained RFID tag of the present invention.

FIG. 4 illustrates several CD boxes, each CD equipped with a daisy chained RFID tag according to the present invention and arranged properly in a shelf.

FIGS. 5 and 6 depict further examples of the design of daisy chained RFID tags according to the present invention.

### DETAILED DESCRIPTION OF THE INVENTION

The present invention provides improved powerless Radio Frequency Identification (RFID) tags providing long reading ranges.

The invention provides improved RFID tags having embedded visual indication means.

The invention provides improved low cost RFID tags providing long reading ranges.

The invention provides improved RFID tags of which the power scheme is based on electrical contacts for receiving power from external sources through electrical connections.

The proposed invention aims to address the problem of identifying a mediatheque object, with an innovative RFID tag which allows long reading range while being equivalent in terms of size, form factor and price to the passive RFID tags. In the following description, DCRFID stands for “Daisy Chained RFID”.

The core of any RFID system is the ‘Tag’ or ‘Transponder’, which can be attached to or embedded within objects, wherein data can be stored. A RFID reader, generically referred to as reader in the following description, sends out a radio frequency signal to the RFID tag that broadcasts back its stored data to the RFID reader. The system works basically as two separate antennas, one antenna on the RFID tag and the other antenna on the RFID reader. The read data can either be transmitted directly to another system like a host computer through standard interfaces, or the read data can be stored in a portable reader and later uploaded to the computer for data processing. A RFID tag system works effectively in environments with excessive dirt, dust, moisture, and/or poor visibility and generally overcomes the limitations of other automatic identification approaches.

Several kinds of RFID, such as piezoelectric RFID and electronic RFID, are currently available. For example, passive RFID tags do not require battery for transmission since generally, passive RFID tags are powered by the reader using an induction mechanism (i.e., an electromagnetic field is emitted by the RFID reader antenna and received by an antenna localized on the RFID tag). This power is used by the RFID tag to transmit a signal back to the RFID reader carrying the data stored in the RFID tag. Active RFID tags comprise a battery to transmit a signal to a RFID reader. A signal is emitted at a predefined interval or transmitted only when addressed by a RFID reader.

When a passive High Frequency (HF) RFID tag is to be read, the RFID reader sends out a power pulse (e.g., a 134.2 KHz power pulse) to the RFID antenna. The magnetic field generated is ‘collected’ by the antenna in the RFID tag that is tuned to the same frequency. This received energy is rectified and stored on a small capacitor within the RFID tag. When the power pulse has finished, the RFID tag immediately transmits back its data to the RFID reader, using the energy stored within its capacitor as its power source. In one embodiment, 128 bits, including error detection information, are transmitted over a period of 20 ms. This transmitted data from the RFID tag is picked up by the receiving antenna of the RFID reader and decoded by the RFID reader. Once all the data has been transmitted from the RFID tag, the storage capacitor of the RFID tag is discharged, resetting the RFID tag to make the RFID tag ready for the next read cycle. The period between transmission pulses is known as the ‘sync time’ and may last between 20 ms and 50 ms depending on the system setup. A transmission technique that may be used between the RFID tag and the reader is Frequency Shift Keying (FSK) with transmissions in one embodiment comprised between 124.2 kHz and 134.2 kHz. This approach has comparatively good resistance to noise while also being very cost effective to implement. Many applications require that RFID tag attached to objects be read while traveling at specific speeds by a readout antenna.

RFID tags can be read-only, write-once, or read-write. A read-only RFID tag comprises a read-only memory that is loaded during manufacturing process. The content of read-only RFID tag cannot be modified. The write-once RFID tags differ from the read-only RFID tags in that the write-once RFID tags can be programmed by the end-user with the required data (e.g., part number or serial number). The read-write RFID tags allow for full read-write capability, allowing a user to update information stored in a tag as often as possible subject to the limit of the memory technology. Generally, the number of write cycles may be limited (e.g., to about 500,000) while the number of read cycles is not limited. A detailed technical analysis of RFID tag is disclosed in RFID (McGraw-Hill Networking Professional) by Steven Shepard, edition Hardcover.

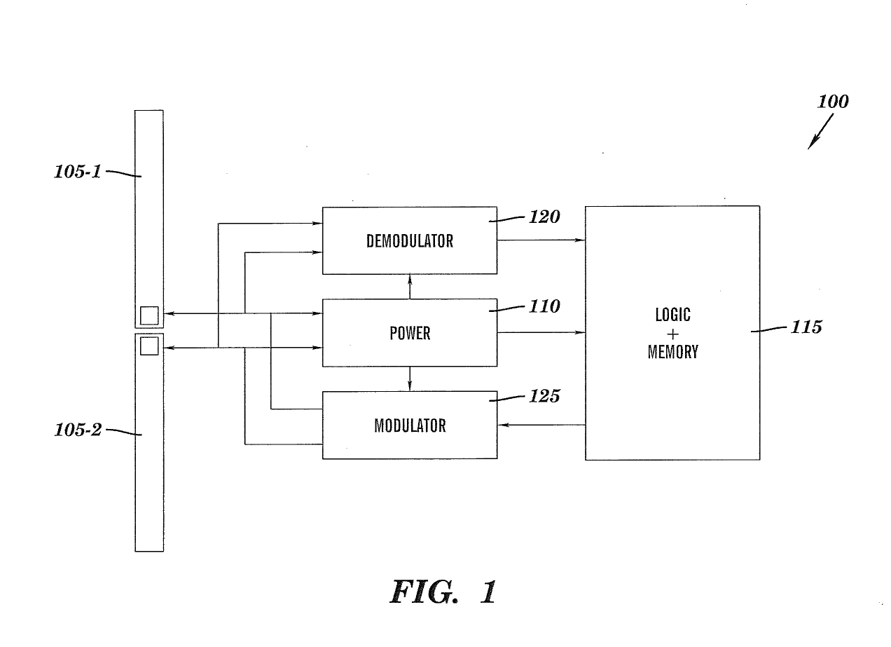

FIG. 1 depicts an example of the architecture of a passive High Frequency (HF) or Ultra High Frequency (UHF) RFID tag 100. As shown, the dipole antenna comprising two parts 105-1 and 105-2 is connected to a power generating circuit 110 that provides current from a received signal to the logic and memory circuit 115, to the demodulator 120, and to the modulator 125. The input of demodulator 120 is connected to the antenna (105-1 and 105-2) for receiving the signal and for transmitting the received signal to the logic and memory circuit 115, after having demodulated the received signal. The input of modulator 125 is connected to the logic and memory circuit 115 for receiving the signal to be transmitted. The output of modulator 125 is connected to the antenna (105-1 and 105-2) for transmitting the signal after the signal has been modulated in modulator 125.

The architecture of a semi-passive RFID tag is similar to the one represented in FIG. 1, the main difference being the presence of a power supply that allows the semi-passive RFID tag to function with much lower signal power levels, resulting in greater reading distances. Semi-passive tags do not have an integrated transmitter in contrast with active tags that comprise a battery and an active transmitter allowing the active tags to generate high frequency energy and to apply the high frequency energy to the antenna.

As disclosed in “A basic introduction to RFID technology and its use in the supply chain”, White Paper, Laran RFID, when the propagating wave from the reader collides with tag antenna in the form of a dipole, part of the energy of the propagating wave is absorbed to power the tag and a small part of the energy of the propagating wave is reflected back to the reader in a technique known as back-scatter. Theory dictates that for the optimal energy transfer, the length of the dipole must be equal to half the wave length λ, or λ/2. Generally, the dipole is made up of two λ/4 lengths. Communication from tag to reader is achieved by altering the antenna input impedance in time with the data stream to be transmitted. This results in the power reflected back to the reader being changed in time with the data; i.e., the signal is modulated.

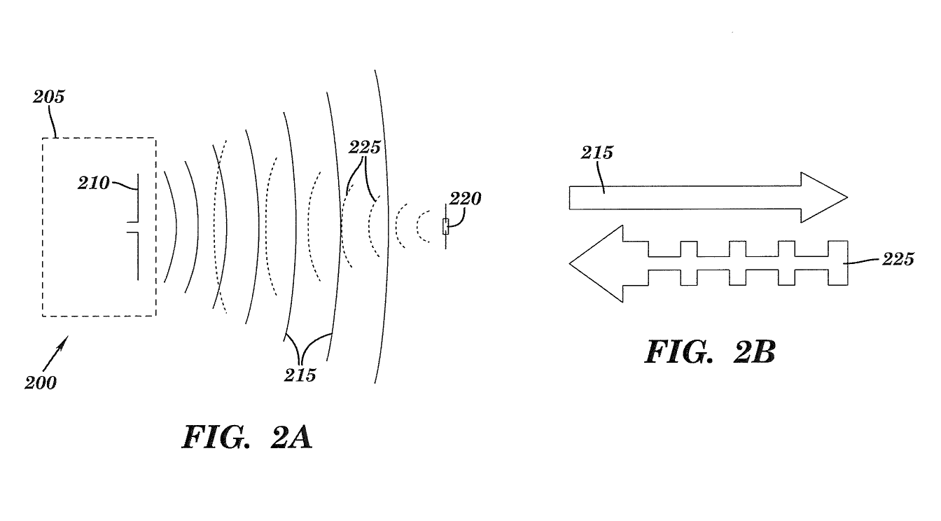

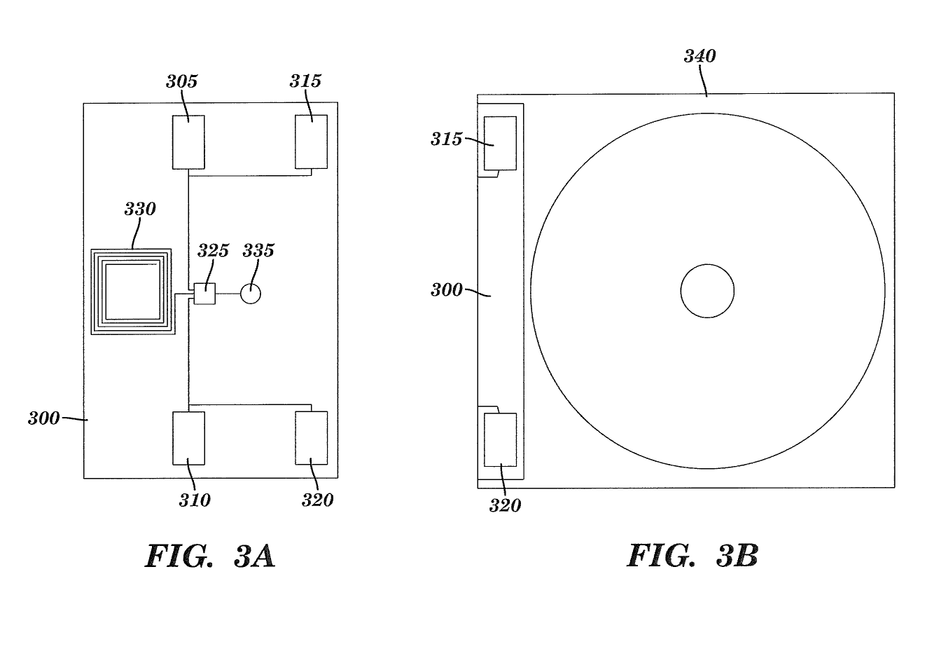

FIGS. 2A and 2B, shows an RFID system 200. As depicted in FIG. 2A, RFID system 200 comprises a reader 205 having an antenna 210. The antenna 210 emits a signal 215 that is received by an RFID tag 220. Signal 215 is reflected by RFID tag 220 as illustrated with dotted lines referred to as 225. FIG. 2B illustrates the signal 215 emitted by the antenna 210 of the reader 205 and the signal 225 reflected by the RFID tag 220. As shown in FIG. 2B, the reflected signal 225 is modulated.

RFID tags are autonomous electronic devices of which data can be accessed without any physical contact. Due to their internal power, the reading distance of active or semi-passive RFID tags is greater than the reading distance of passive RFID tag receiving power from their antenna. However, active or semi-passive RFID tags present drawback due to the internal power source that increases costs and reduces life cycle.

The DCRFID tag of the present invention encompass the architecture of active or semi-passive RFID tags in combination with with external power sources, offering the advantages of the active or semi-passive RFID tags without the drawbacks resulting from the internal power source.

The main characteristics of the DCRFID tag are: long reading range (typically up to 10 meters); visual identification of a targeted DCRFID tag due to an imbedded tiny Light Emitting Diode (LED); convenient form factor enabling the DCRFID tag to be attached to or embedded in the objects; low production costs; and a power scheme based on electrical contacts enabled by proper stacking of DCRFIDs.

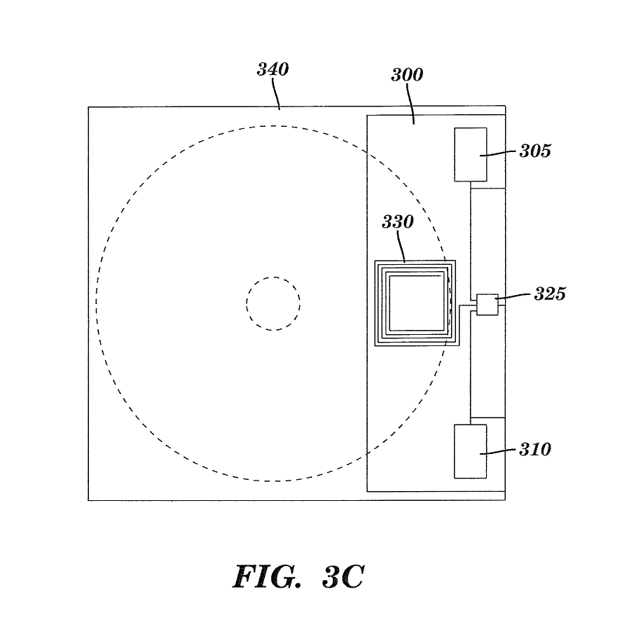

FIGS. 3A, 3B, and 3C illustrate the DCRFID tag. FIG. 3A depicts the DCRFID tag itself while FIGS. 3B and 3C show the front view and the rear view, respectively, of a Compact Disc (CD) box on which the DCRFID tag is attached.

As illustrated on FIG. 3A, the DCRFID tag 300 comprises two pairs of electrical contacts (305, 310) and (315, 320), an electronic RFID chip 325, an antenna 330, and a LED 335 or any equivalent lighting device. The two pairs of electrical contacts (305, 310) and (315, 320) enable receiving and transmitting power from an external source (not represented). For example, contact 305 receives power or current from the external source, contact 315, being connected to contact 305, transmits received power or current, and contacts 310 and 320, being connected together, are also connected to ground. RFID chip 325, which may be of the active or semi-passive type, is connected to the pairs of electrical contacts (305, 310) and (315, 320) for receiving power. RFID chip 325 is connected to antenna 330 to receive data and/or control commands from a RFID reader. LED 335 (or an equivalent lighting device) is controlled by RFID chip 325 so that LED 335 can be powered according to conditions determined by received instructions and data stored therein. For example, if the received data match the stored data, the LED is powered during a predetermined delay.

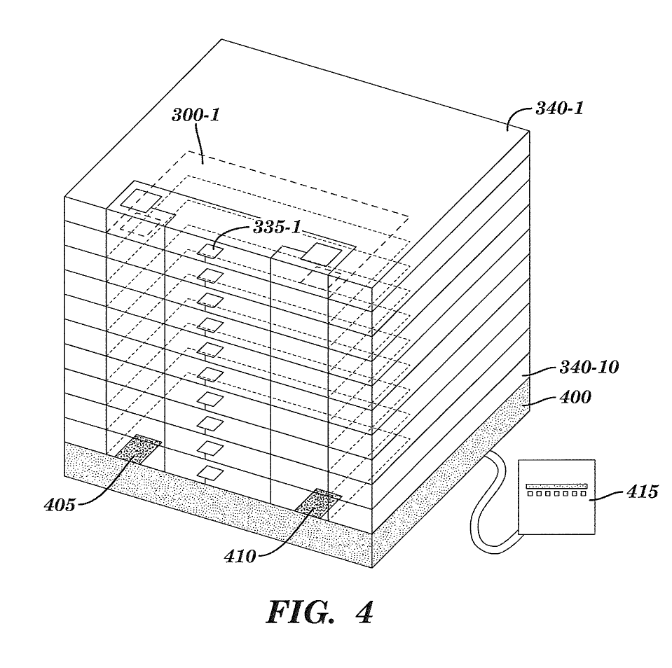

Electrical contacts 305, 310, 315, and 320 are arranged in such a way so that the contacts 315 and 320 of a first DCRFID are respectively touching (i.e., in mechanical and electrical contact with) the contacts 305 and 310 of a second DCRFID when these two DCRFID are attached to stacked objects, as described below by reference to FIG. 4.

FIGS. 3B and 3C show an example where a DCRFID 300 is attached to a CD box 340. DCRFID 300 is preferably attached to the edge of the CD box so that LED 335 is visible when the CD box is stacked with other CD boxes so that electrical contacts can be established with neighboring DCRFIDs.

FIG. 4 illustrates several essentially identical CD boxes equipped each with a DCRFID and arranged properly in a shelf. With reference to the FIG. 4, a set of ten CD boxes 340-1 to 340-10 are stacked one above the other, forming a vertical stack. Each CD box is equipped with a DCRFID as described above by reference to FIG. 3. DCRFID 300-1 is attached to CD box 340-1, DCRFID 300-2 is attached to CD box 340-2, and so on. According to this arrangement, the set of LEDs of the DCRFIDs (e.g., LED 335-1) are aligned in a column, so that any DCRFID tag identified by a reader will light the LED for easy identification of the DCRFID. The DCRFIDs 300-1, 300-2, . . . 300-10 are essentially identical DCRFIDs arranged in a stack of DCRFIDs. This stack of CD boxes sits above a pedestal base 400 comprising two electrical contacts 405 and 410 which receive power from an external power source 415. These contacts 405 and 410 are aligned with the contacts of the DCRFID, to establish the received voltage between the contacts 305-10 and 310-10 of the bottom CD box. Since contacts 305-10 and 310-10 are respectively connected to contacts 315-10 and 320-10, and since contacts 315-10 and 320-10 are respectively connected to the contacts 305-9 and 310-9, forming an electrical continuity between contacts 315-10 and 305-9, and between contacts 320-10 and 310-9, the same voltage is applied to contacts 315-10 and 305-9, and so on along this “daisy chain” of contacts, resulting in the same voltage on each CD box from the bottom CD box up to the top CD box.

With the arrangement described on FIG. 4, the unique identification of a given CD box is easy. The user first selects the CD to be searched. Then the user identifies the associated identifier, due to some defined relationship between a CD and an identifier. Such a relationship is beyond the scope of the present invention, but it typically corresponds, in one embodiment of the present invention, to an association with an Electronic Product Code (EPC). Then the user utilizes an RFID reader, fed with the identifier in a signal, so that all DCRFIDs in range receive a reading trigger in the signal from the RFID reader. Each DCRFID receiving this reading trigger carrying the identifier compares the received identifier with its own identifier. If the identifier of the reading trigger and the DCRFIDs own identifier do not match, the DCRFID does not react to the reading trigger. If they match, then the DCRFID reacts by lighting its LED, which allows the user to immediately identify the searched CD. If this CD is pulled out of the vertical stack, then the remaining CD's, if any, will still be powered due to the propagation of energy from the pedestal base up to the top CD.

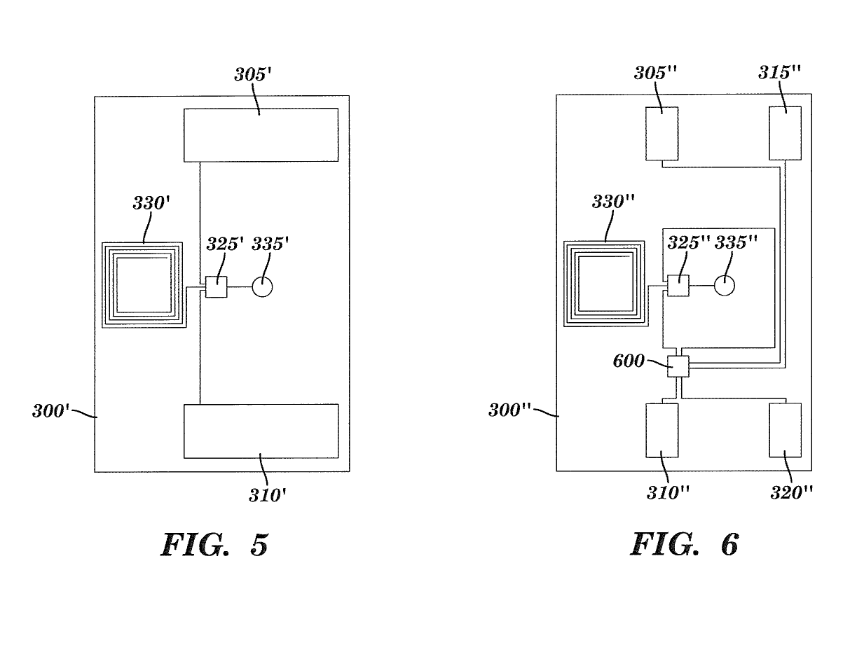

FIGS. 5 and 6 illustrate further examples of DCRFID designs. In FIG. 5, the DCRFID 300′ comprises a single pair of contacts 305′ and 310′, a RFID chip 325′, an antenna 330′, and a LED 335′ or any equivalent lighting device. The contacts 305′ and 310′ are designed in such a way that they can establish electrical contacts with neighboring DCRFIDs as described by reference to FIG. 4. To that end, the contacts 305′ and 310′ extend on each side of the object (e.g., CD) on the edge of which the DCRFID is attached.

FIG. 6 depicts an embodiment of the DCRFID according to the present invention, further comprising a power controller 600. Like the DCRFID 300 of FIG. 3, the DCRFID 300″ of FIG. 6 comprises two pairs of electrical contacts (305″, 310″) and (315″, 320″), an RFID chip 325″, an antenna 330″, and a LED 335″ or any equivalent lighting device. Each contact 305″, 310″, 315″, and 320″ is connected to the power controller 600. Outputs of the power controller 600 are connected to the RFID chip 325″ for powering this chip. The power controller 600 determines which pair of contacts (305″, 310″) or (315″, 320″) is powered and the polarity of the received power. The received power is transmitted to the non-powered pair of contacts (305″, 310″) or (315″, 320″) and to the RFID chip 325″ according to a predetermined polarity (i.e., depending upon the received power polarity, the output polarity of the power controller 600 is reversed or not).

The DCRFID according to FIG. 6 enables stacking the objects on which the DCRFID is attached on one side or on the other side. For example, some CD boxes of FIG. 4 equipped with the DCRFID of FIG. 6 can be stacked upside down.

Without departing from the spirit of the proposed invention, some enhancements can be proposed along the following points. The stack of CD boxes can be arranged horizontally, while spring means ensure that all CD boxes remain in contact. The layout and the number of the contacts may vary, provided that stacked objects present their contacts as being electrically connected. The power source can be located in the pedestal base, using for instance a battery.

In order to satisfy local and specific requirements, a person skilled in the art may apply to the solution described above many modifications and alterations, all of which are included within the scope of protection of the invention.

What is claimed is:

1. A Radio Frequency Identification (RFID) structure comprising a tag stack of N essentially identical RFID tags and an object stack of N essentially identical objects:
wherein N is at least 2;
wherein each tag of the N tags is attached to a corresponding object of the N objects;
wherein the N tags are denoted as T₁, T₂, . . . , T_{N};
wherein each tag comprises an electronic chip, an antenna, and at least one pair of electrical contacts, said at least one pair of electrical contacts of T₁, T₂, . . . , T_{N} respectively denoted as C₁, C₂, . . . , C_{N};
wherein the N tags are daisy chained together such that Cᵢ is in electrical contact with Cᵢ₊₁ for i=1, 2, . . . , N−1;
wherein in each tag, the antenna is configured to receive an external signal from outside the RFID structure and to transmit the external signal to the chip which is configured to receive the signal from the antenna via an electrical connection between the antenna and the chip; and
wherein the tag stack is configured to receive power from an external power source located outside of the RFID structure.

2. The RFID structure of claim 1,
wherein T₁ is the only tag of the N tags configured to be directly electrically connected to the external power source;
wherein T₁ is configured to have power from the external power source enter the tag stack at C₁ and be transmitted to the N tags by being conducted through C₁, C₂, . . . , C_{N}; and
wherein in each tag, the chip is configured to receive the power conducted through the at least one pair of electrical contacts via an electrical connection between the at least one pair of electrical contacts and the chip.

3. The RFID structure of claim 2, wherein each tag does not comprise an internal power source that is internal to said each tag.

4. The RFID structure of claim 1,
wherein each tag comprises a lighting device; and
wherein in each tag, the chip is electrically connected to the lighting device and is configured to enable or not enable a lighting of the lighting device, in dependence upon data in the external signal received by the chip from the antenna.

5. The RFID structure of claim 1, wherein in each tag, the at least one pair of electrical contacts consist of one pair of electrical contacts.

6. The RFID structure of claim 1, wherein in each tag, the at least one pair of electrical contacts comprises two pairs of electrical contacts.

7. The RFID structure of claim 6, wherein a first pair of the two pairs comprised by Cᵢ is in electrical contact with a second pair of the two pairs comprised by Cᵢ₊₁ such that the first pair within Cᵢ does not spatially correspond to the second pair within Cᵢ₊₁, for i=1, 2, . . . , N−1.

8. The RFID structure of claim 6,
wherein each tag comprises a power controller electrically connected to each pair of the two pairs of electrical contacts; and
wherein in each tag, only one pair of the two pairs of electrical contacts can be powered at any given time and the power controller is configured to determine which pair of the two pairs is powered by the conducted electrical power and is further configured to power the chip with the conducted electrical power in accordance with a predetermined polarity.

9. The RFID structure of claim 8, wherein in each tag, the power controller is configured to power a non-powered pair of the two pairs of electrical contacts that is not powered according to the predetermined polarity.

10. The RFID structure of claim 1, wherein T₁ is directly electrically connected to the external power source.

11. A method for localizing an object in a Radio Frequency Identification (RFID) structure that comprises a tag stack of N essentially identical RFID tags and an object stack of N essentially identical objects, said method comprising:
receiving by the N tags an external signal from outside the RFID structure,
wherein N is at least 2,
wherein each tag of the N tags is attached to a corresponding object of the N objects,
wherein the N tags are denoted as T₁, T₂, . . . , T_{N},
wherein each tag comprises an electronic chip, an antenna, and at least one pair of electrical contacts, said at least one pair of electrical contacts of T₁, T₂, . . . , T_{N} respectively denoted as C₁, C₂, . . . , C_{N},
wherein the N tags are daisy chained together such that Cᵢ is in electrical contact with Cᵢ₊₁ for i=1, 2, . . . , N−1,
wherein the tag stack is receiving power from an external power source located outside of the RFID structure,
wherein each tag comprises a lighting device such that the chip in each tag is electrically connected to the lighting device in each tag,
wherein in each tag, the antenna receives the external signal; and
in each tag,
transmitting the external signal from the antenna to the chip via an electrical connection between the antenna and the chip,
receiving, by the chip, the external signal transmitted by the antenna,
extracting, by the chip, data in the external signal received by the chip, and
enabling or not enabling, by the chip, a lighting of the lighting device in dependence upon the extracted data.

12. The method of claim 11, wherein each tag stores a unique identifier of the object to which each tag is attached, wherein the data in the external signal comprises the unique identifier of one object of the N objects, and wherein the method further comprises: in each chip,
ascertaining, by the chip, whether the unique identifier of the one object in the data in the external signal matches the stored unique identifier of the object to which the tag is attached;
enabling, by the chip, the lighting of the lighting device if said ascertaining has ascertained that the unique identifier of the one object in the data in the external signal matches the stored unique identifier of the object to which the tag is attached;
not enabling, by the chip, the lighting of the lighting device if said ascertaining has ascertained that the unique identifier of the one object in the data in the external signal does not match the stored unique identifier of the object to which the tag is attached.

13. The method of claim 11, wherein the lighting device is a light emitting diode (LED).

14. The method of claim 11,
wherein T₁ is the only tag of the N tags directly electrically connected to the external power source,
wherein power from the external power source enters the stack at C₁ and is transmitted to the N tags by being conducted through C₁, C₂, . . . , C_{N}, and
wherein in each tag, the chip receives the power conducted through the at least one pair of electrical contacts via an electrical connection between the at least one pair of electrical contacts and the chip.

15. The method of claim 11, wherein each tag does not comprise an internal power source that is internal to said each tag.

16. The method of claim 11, wherein in each tag, the at least one pair of electrical contacts consist of one pair of electrical contacts.

17. The method of claim 12, wherein in each tag, the at least one pair of electrical contacts comprises two pairs of electrical contacts.

18. The method of claim 17, wherein a first pair of the two pairs comprised by Cᵢ is in electrical contact with a second pair of the two pairs comprised by Cᵢ₊₁ such that the first pair within Cᵢ does not spatially correspond to the second pair within Cᵢ₊₁, for i=1, 2, . . . , N−1.

19. The method of claim 17,
wherein each tag comprises a power controller electrically connected to each pair of the two pairs of electrical contacts in each tag;
wherein in each tag, only one pair of the two pairs of electrical contacts can be powered at any given time;
wherein the method further comprises: in each tag,
determining, by the power controller, which pair of the two pairs is powered by the conducted power, and
powering the chip, by the power controller, with the conducted power in accordance with a predetermined polarity.

20. The method of claim 19, wherein the method further comprises: in each tag, powering a non-powered pair of the two pairs of electrical contacts that is not powered according to the predetermined polarity.
